(19) United States
(12) Patent Application Publication
(10) Pub. No.: US 2005/0258257 A1
(43) Pub. Date: Nov. 24, 2005

(54) Temperature control unit

(76) Inventors: Billy W. Thurman JR., Ardmore, OK (US); Chad West, Ardmore, OK (US)

Correspondence Address: SIMON, GALASSO & FRANTZ PLC, P.O. Box 26503, Austin, TX, 78755-0503, US

(21) Appl. No.: 11/012,400

(22) Filed: Dec. 14, 2004

Related U.S. Application Data
(60) Provisional application No. 60/529,892, filed on Dec. 16, 2003.

(51) Int. Cl. G05D 23/00

(52) U.S. Cl. 236/1 C

(57) ABSTRACT

A device for heating and cooling an enclosed area, such as the passenger of a motor vehicle. The device includes a temperature control unit for a user to interface with the device and allow the setting of the threshold operating temperatures. A temperature switch is used to control the initiation and termination of the heating and cooling unit. When an upper threshold is reached, the temperature switch indicates to a control unit to place the heating and cooling unit in cool mode and blow cool air into the enclosed area until the ambient temperature is cooled below the upper threshold, whereby the heating and cooling unit is deactivated. Similarly, when a lower threshold is passed, the temperature switch indicates to the control unit to place the heating and cooling unit in heat mode and blow heated air into the enclosed area until the ambient temperature is heated above the lower threshold, whereby the heating and cooling unit is deactivated. This device being powered by solar panels.

### PRIORITY UNDER 35 U.S.C. §119(e) & 37 C.F.R. §1.78

This nonprovisional application claims priority based upon the following prior United States provisional patent application entitled: Westman, Application No. 60/529,892, filed Dec. 16, 2003, in the names of Billy W. Thurman, Jr. and Chad West, which is hereby incorporated by reference for all purposes.

### FIELD OF THE INVENTION

The present invention relates to a temperature control system, and more particularly, but not by way of limitation, to a solar powered system for monitoring and controlling the temperature of a small enclosed interior area, such as the passenger compartment of a vehicle.

### BACKGROUND

Heat and cold creates not only an uncomfortable environment for drivers and passengers in a vehicle, but it also degrades the vehicles interior, especially when the vehicle is left out in the elements. Although most vehicles have heating and cooling systems, they operate off the cars engine. This not only decreases the fuel efficiency of the vehicle, but it is also impractical to operate when the vehicle is parked and not being used. Therefore, it is desirable to have a solar powered system that can monitor and control the of a vehicle.

### BRIEF DESCRIPTION OF THE DRAWING FIGURES

A more complete understanding of the present invention may be had by reference to the following Detailed Description and appended claims when taken in conjunction with the accompanying Drawings wherein:

FIG. 1 illustrates a preferred embodiment of a temperature control unit in accordance with the principles of the present invention; and

FIG. 2 illustrates an alternative embodiment of a temperature control unit in accordance with the principles of the present invention.

### DETAILED DESCRIPTION

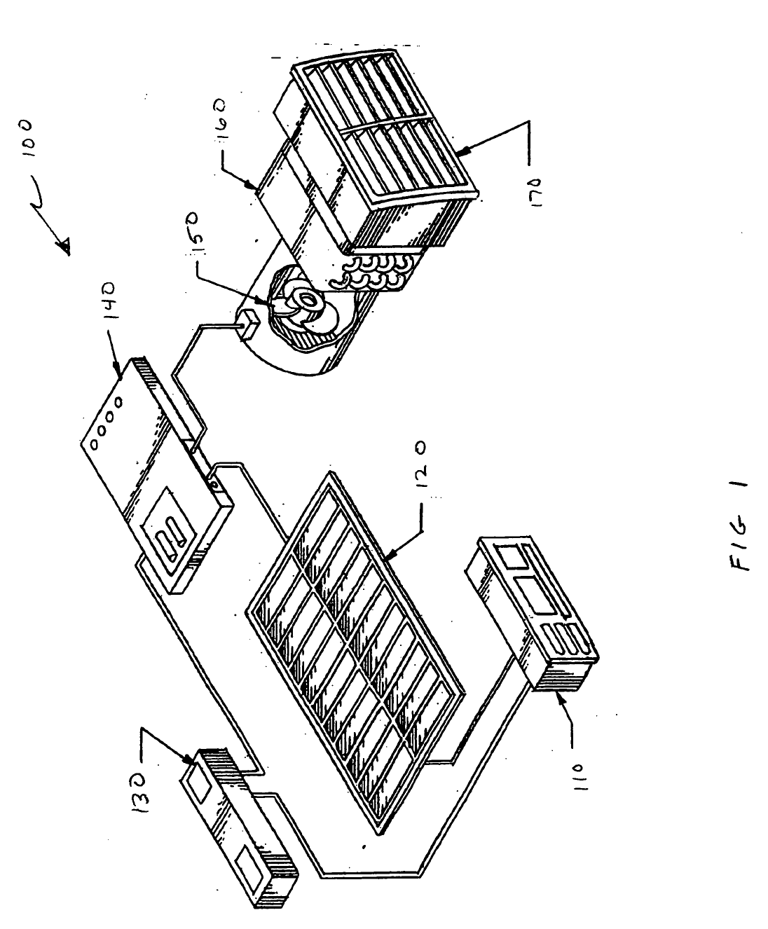

Referring now to FIG. 1, there is illustrated a preferred embodiment a temperature monitor and control system 100 in accordance with the present invention wherein the various elements depicted are not necessarily drawn to scale. Temperature monitor and control system 100 includes a temperature control unit 110, solar panels 120, a temperature switch 130, solar circuit and fan drive 140, fan 150, and a cooling/heating unit 160.

The temperature control unit 110 allows a user's input, including the setting of the desired operating temperatures, and further includes a thermometer for measuring and monitoring the ambient temperature of the compartment. Temperature control unit 110 is typically a computer controlled system, with an input panel as well as a display panel. The display panel could display the set temperature of temperature monitor and control system 100 as well as the current ambient temperature of the compartment. It is contemplated that temperature control unit 110 could also keep track of and display various operating and temperature statistics of temperature monitor and control system 100 over a set period of time. It is contemplated that the temperature control unit could operate in either a heating mode, a cooling mode, or set a range of temperatures, such that if the temperature drops a lower threshold, the heating mode would engage, and if the temperature rises above an upper threshold, the cooling mode would engage.

As depicted in FIG. 1, solar panels 120 are connected to temperature control unit 110, and supply to power to the not only to the temperature control unit 110, but also to the rest of the temperature monitor and control system 110.

Also connected to temperature control unit 110 is a temperature switch 130. The user operating settings entered into the temperature control unit 110 set the threshold operating parameters of temperature switch 130.

Still referring to FIG. 1, connected to the temperature switch 130 and solar panels 120 is the solar circuit fan drive 140. The solar circuit fan drive 140 regulates the power supplied by the solar panels 120 to the fan 150, and a cooling/heating unit 160.

In a preferred embodiment temperature monitor and control system 100 is installed in a motor vehicle, such as an automobile, with the temperature of the passenger compartment being monitored and controlled. In operation when the temperature of the compartment reaches the user setting, such as an upper temperature setting, the solar circuit fan drive 140 is activated via temperature switch 130, the fan 150 is activated, and the cooling/heating unit 160 is turned to cooling mode. The cool air is then blown into the passenger compartment through the outlet or vents 170. Similarly if the lower temperature setting is reached, the solar circuit fan drive 140 is activated via temperature switch 130, the fan 150 is activated, and the cooling/heating unit 160 is turned to heating mode. The warm air is the blown into the passenger compartment through the outlet or vents 170. In either operating mode, when the desired temperature changes is reached, solar circuit fan drive 140 shuts down fan 150 and cooling/heating unit 160.

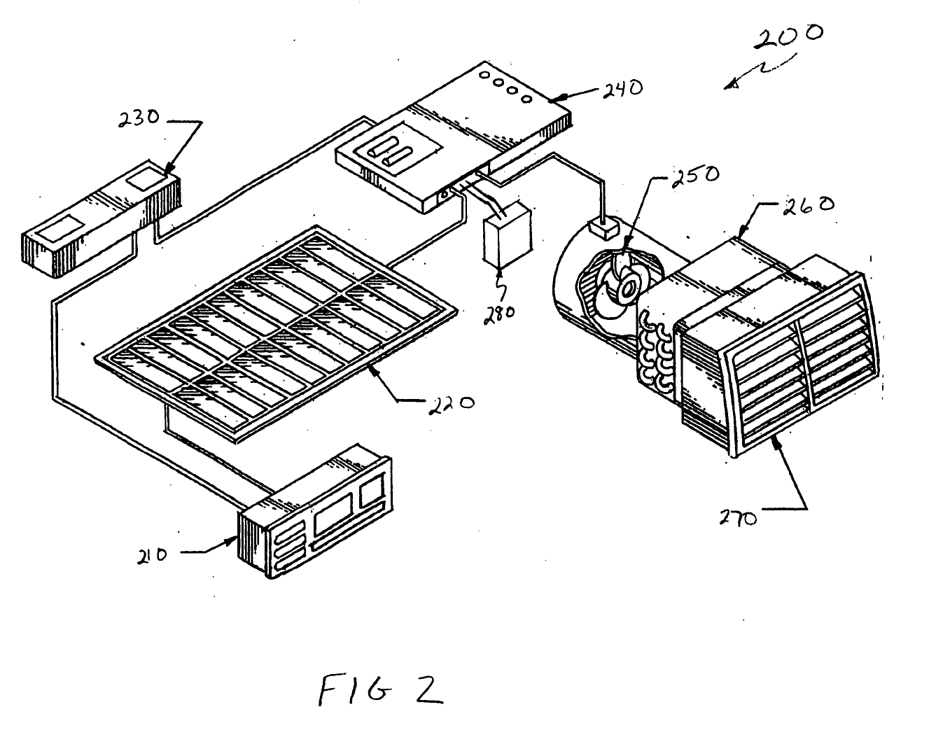

Referring now to FIG. 2, there is illustrated an alternative embodiment a temperature monitor and control system 200 in accordance with the present invention wherein the various elements depicted are not necessarily drawn to scale. Temperature monitor and control system 200 includes a temperature control unit 210, solar panels 220, a temperature switch 230, solar circuit and fan drive 240, fan 250, a cooling/heating unit 260, vents 270, and a rechargeable power pack 280.

Temperature monitor and control system 200 is similar in design and operation to that illustrated in FIG. 1 with the addition of rechargeable power pack 280 connected to solar circuit and fan drive 240. Solar circuit and fan drive 240 not only regulates the charging of rechargeable power pack 280, but also regulates the draw of power from the rechargeable power pack 280 when the power being supplied by solar panels 220 is insufficient to operate fan 250 and cooling/heating unit 260. In operation, if fan 250 and cooling/heating unit 260 are not activated, some of the power from solar panels 220 is being used to charge rechargeable power pack 280. When the need arises to activate fan 250 and cooling/heating unit 260, the power needed can come from solar panels 220, rechargeable power back 280, or both.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. A device for monitoring and modifying the temperature of an enclosed area, comprising:
a user input device for inputting a first temperature threshold;
a temperature switch connected to the user input device for receiving the first temperature threshold and for detecting change in the temperature of the enclosed area;
a heating and cooling unit operable when said temperature switch detects the change in the temperature of the enclosed area reaches the first temperature threshold; and
a power supply for supplying power to said user input device, said temperature switch, and said heating and cooling unit.

2. The device as recited in claim 1, wherein said power supply includes solar panels for converting light energy into electrical energy.

3. The device as recited in claim 1, further including a controller connected to said temperature switch and said power supply, said controller for initiating and terminating operation of said heating and cooling unit in response to said temperature switch.

4. The device as recited in claim 3, wherein said controller further for regulating power from said power supply to said heating and cooling unit.

5. The device as recited in claim 1, wherein said heating and cooling unit includes a fan to move air from the heating and cooling unit into the enclosed area.

6. The device as recited in claim 1, wherein said input device for receiving a second temperature threshold, wherein said heating and cooling unit operates in a cooling mode when said temperature switch detects the change in the temperature of the enclosed area reaches the first temperature threshold, and further wherein said heating and cooling unit operates in a heating mode when said temperature switch detects the change in the temperature of the enclosed area reaches the second temperature threshold.

7. A device for monitoring and modifying the temperature of an small enclosed area, comprising:
a user input device allowing a user to input a first temperature threshold;
a temperature switch connected to the user input device for receiving the first temperature threshold and for detecting change in the temperature of the enclosed area;
a heating and cooling unit operable in a heating mode and a cooling mode, said heating and cooling unit activated when said temperature switch detects the change in the temperature of the small enclosed area reaches the first temperature threshold; and
a power supply for supplying power to said user input device, said temperature switch, and said heating and cooling unit.

8. The device as recited in claim 7, wherein said power supply comprises solar panels for converting light energy into electrical energy.

9. The device as recited in claim 7, further including a controller connected to said temperature switch and said power supply, said controller for initiating and terminating operation of said heating and cooling unit in response to said temperature switch detecting the change in the temperature of the small enclosed area reaching the first temperature threshold.

10. The device as recited in claim 9, wherein said controller further for regulating power from said power supply to said heating and cooling unit.

11. The device as recited in claim 7, wherein said heating and cooling unit includes a fan to move air from the heating and cooling unit into the enclosed area.

12. The device as recited in claim 1, wherein said input device for receiving a second temperature threshold, wherein said heating and cooling unit operates in the cooling mode when said temperature switch detects the change in the temperature of the enclosed area reaches the first temperature threshold, and further wherein said heating and cooling unit operates in the heating mode when said temperature switch detects the change in the temperature of the enclosed area reaches the second temperature threshold.

13. A device for monitoring and modifying the temperature of an small enclosed area, comprising:
a user input device allowing a user to input a first temperature threshold;
a temperature switch connected to the user input device for receiving the first temperature threshold and for detecting change in the temperature of the enclosed area;
a heating and cooling unit operable in a heating mode and a cooling mode, said heating and cooling unit activated when said temperature switch detects the change in the temperature of the small enclosed area reaches the first temperature threshold; and
a power supply for supplying power to said user input device, said temperature switch, and said heating and cooling unit.

14. The device as recited in claim 13, wherein said power supply includes solar panels for converting light energy into electrical energy.

15. The device as recited in claim 14, wherein said power supply includes a rechargeable battery operable to supply power to at least the heating and cooling unit, and further operable to be recharged by the electrical energy from said solar panels.

16. The device as recited in claim 15, further including a controller connected to said temperature switch and said power supply, said controller for initiating and terminating operation of said heating and cooling unit in response to said temperature switch detecting the change in the temperature of the small enclosed area reaching the first temperature threshold.

17. The device as recited in claim 16, wherein said controller further for regulating the charging of said rechargeable battery.

18. The device as recited in claim 17, wherein said controller further for regulating power from said power supply to said heating and cooling unit.

19. The device as recited in claim 18, wherein said heating and cooling unit includes a fan to move air from the heating and cooling unit into the enclosed area.

20. The device as recited in claim 19, and further including air vents connected to said heating and cooling unit.
